(19) United States
(12) Patent Application Publication
(10) Pub. No.: US 2010/0044542 A1
(43) Pub. Date: Feb. 25, 2010

(54) FEEDER DEVICE

(75) Inventor: Yoshitaka KOGA, Chiryu-shi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: AISIN SEIKI KABUSHIKI KAISHA, Kariya-shi (JP)

(21) Appl. No.: 12/543,820

(22) Filed: Aug. 19, 2009

(30) Foreign Application Priority Data
Aug. 22, 2008 (JP) 2008-214295

(51) Int. Cl. F16H 25/20; B60N 2/075; B60N 2/07

(52) U.S. Cl. 248/429; 74/89.23

(57) ABSTRACT

The feeder device includes a screw attached to one of a fixed member and a movable member relatively movably supported by the fixed member, a support member attached to the other one of the fixed and movable members and including a hole into which the screw is inserted, a nut member disposed inside the support member and including a nut with a female screw with which a male screw provided at the screw engages, the nut member being relatively movable in an axial direction, an elastic case disposed between the nut member and the support member, the elastic member including a hole, axial center of which is the same with the female screw and elastically holding the male screw at an inner peripheral surface and a pressure-contact surface elastically holding the nut member by pressure contact therewith and a drive device for drivingly rotating the screw or the nut.

This application is based on and claims priority under 35 U.S.C. §119 to Japanese Patent Application 2008-214295, filed on Aug. 22, 2008, the entire content of which is incorporated herein by reference.

### FIELD OF THE INVENTION

The present invention generally relates to a feeder device and more particularly to a feeder device with screw and nut.

### BACKGROUND

As an example of the feeder device for the seat slide device is shown in a first patent document (No. 1996-156660 A) or a second patent document (No. 1997-123807 A). The device according to the first patent document is comprised of a lower side rail fixed to a floor of a vehicle, an upper side rail movable in a vehicle front/rear direction relative to the lower side rail and supporting a seat of the vehicle thereon and a screw/nut mechanism for moving the upper side rail relative to the lower side rail, whereby the screw is supported on the upper side rail and is rotated by an electric motor of a motor drive device and the nut is supported on the lower side rail and engaged with the screw. The nut is disposed in a support member fixed to the lower side rail through an elastic case.

As shown in the patent document (No. 1996-156660 A), the feeder device includes the nut inserted into the support member through the elastic case. The elastic case and a screw bore provided in the nut are provided with front/rear circular holes, to which axial center of the front/rear circular holes of the support member are coaxially agreed. Another screw is inserted into the circular holes to engage with the screw bore. The elastic case is provided between the support member and the nut for serving as a damper to avoid any guttering noise, which may be generated when the male screw portion of the screw contacts the female screw portion of the nut. At the same time, noise generated upon backrush caused by the switching operation of the screw.

According to the second patent document (No. 1997-123807 A), a downward step portion is provided at the lower side of the nut relative to the screw bore. The elastic case is held at the edge portion between the inner surface of the support member at lower side thereof relative to the insertion bore and the lower side edge surface of the downward step portion of the nut. The elastic case is supported by the downward step portion of the nut to prevent the case from projecting out from the insertion bore of the support member. At the same time the axial guttering generated between the screw and the nut is prevented by direct contact between the opening end of the screw bore of the screw and the insertion bore. Further, the impact generated upon switching operation of the screw.

However, a small gap is generally provided between the male screw portion of the screw and the female screw portion of the nut for allowing a relative rotational movement therebetween. Upon operation, screw moves relative to the nut by contacting with each other.

According to the device shown in the first patent document, an elastic case is press-fittingly disposed between the male screw portion and the female screw portion and the nut makes pressure contact with the screw in an axial direction. This may dampen the impact caused by a backrush of the screw portions in the gap provided between the male and female screw portions when the rotation direction of the screw is switched.

However, the outer diameter of the screw and the inner diameter of the circular bore of the elastic case are not defined and depending on the size of these parts, male and female screw portions may directly contact with each other to generate an impact noise and eventually prevents a smooth feeding operation.

Similarly, according to the device shown in the second patent document, direct contact between the male and female screw portions may occur to induce an impact noise upon operation.

Need thus exists for a feeder device which is not susceptible to the drawbacks mentioned above.

### SUMMARY OF THE INVENTION

The feeder device according to the invention includes a screw adapted to be attached to either one of a fixed member and a movable member relatively movably supported by the fixed member, a support member adapted to be attached to the other one of the fixed member and the movable member and including a through-hole into which the screw is inserted, a nut-side member disposed inside of the support member and including a nut having a female screw portion, with which a male screw portion provided at the screw, engages, the nut-side member being relatively movable in an axial direction relative to the screw, an elastic case formed by an elastic material and disposed between the nut-side member and the support member, the elastic member including a support hole, axial center of which is the same with the female screw portion and elastically holding the male screw portion at an inner peripheral surface and a pressure-contact surface elastically holding the nut-side member by pressure contact therewith and a drive device for drivingly rotating either the screw or the nut of the nut-side member.

### BRIEF DESCRIPTION OF THE DRAWINGS

The foregoing and additional features and characteristics of the present invention will become more apparent from the following detailed description considered with the reference to the accompanying drawings, wherein:

FIG. 1 is a front view of a seat slide device in which a feeder device according to a first embodiment of the invention is applied;

FIG. 2 is an exploded perspective view of the seat slide device in FIG. 1;

FIG. 3 is a cross sectional view of the seat slide device taken along the 3-3 line in FIG. 1;

FIG. 4 is a perspective view of a screw of the feeder device of FIG. 1, to which a feeder nut, elastic case and a support bracket are assembled;

FIG. 5 is an exploded perspective view of the feeder nut, elastic case and the support bracket according to the feeder device FIG. 1;

FIG. 6 is a cross sectional view of the support bracket, the elastic case, the feeder nut and the screw attached to the lower rail of a vehicle seat;

FIG. 7 is a perspective view of a seat slide device in which a feeder device according to a second embodiment of the invention is applied;

FIG. 8 is an exploded perspective view of the seat slide device in which the feeder device according to the second embodiment of the invention is applied; and

FIG. 9 is a cross sectional view of the support bracket, elastic case, drive nut and the screw attached to the upper rail according to the second embodiment of the invention, taken along the line 9-9 in FIG. 7.

### DETAILED DESCRIPTION

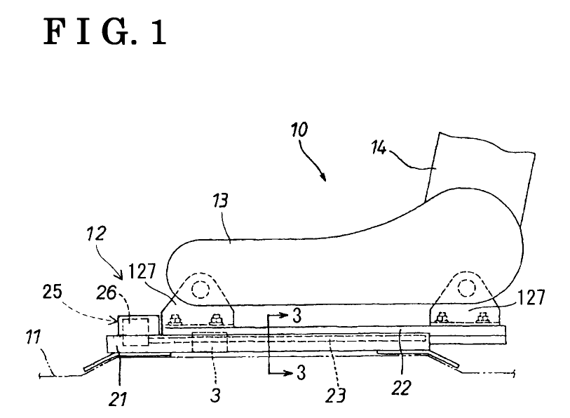

Embodiments of the invention will be explained hereinafter with reference to the attached drawings. In the drawings, the words, “right and left”, “front and rear”, and “upper and lower” indicate directions viewed by an occupant of the vehicle seated in the vehicle seat. In FIG. 1, numeral 10 indicates a vehicle seat provided on a vehicle floor 11. The vehicle seat 10 includes a seat slide device 12, which will be later explained in detail. The seat 10 includes a seat cushion 13 serving as the seating surface and a seat back 14 serving as the back rest surface.

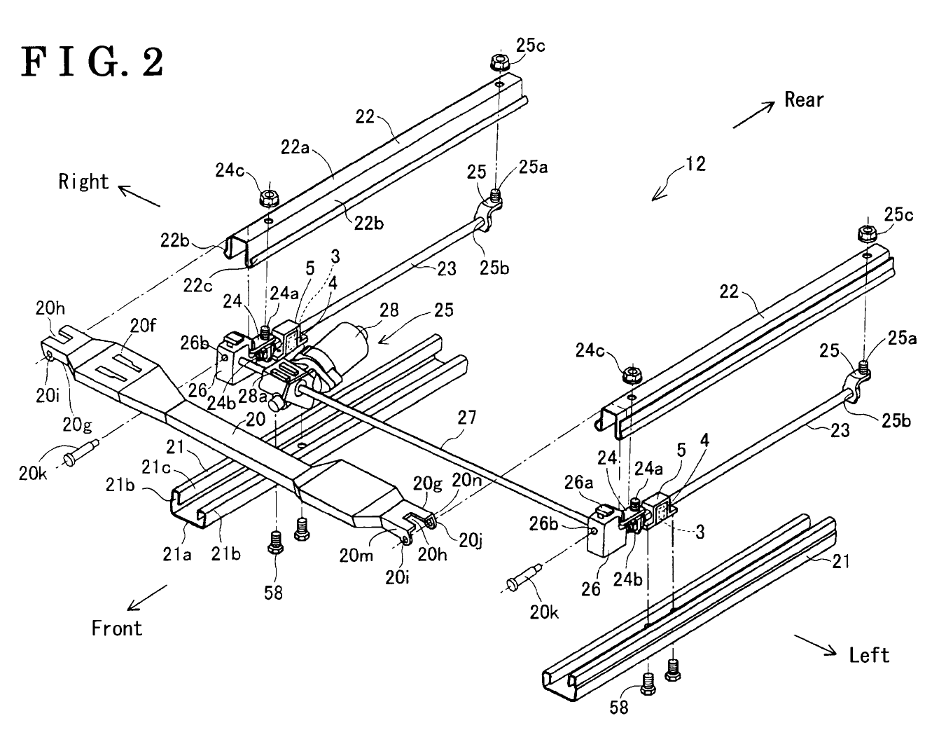

As shown in FIGS. 1 and 2, the seat slide device 12 includes a pair of lower rails 21, a pair of upper rails 22, a pair of screws 23, a pair of feeder nuts 3 and a single drive device 25.

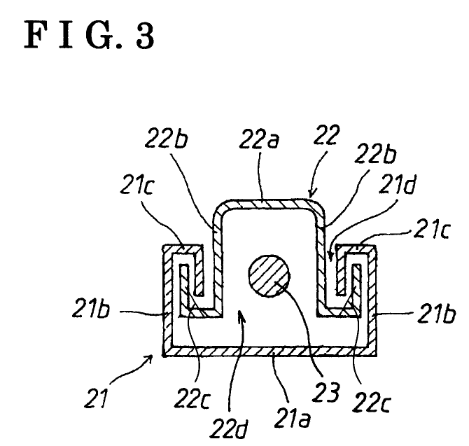

As shown in FIGS. 1 and 3, the lower rail 21 has an elongated rectangular shape extending in a vehicle front/rearward direction and is formed by a pair of right and left rail members in parallel with each other. Each of the pair of lower rails 21 includes a bottom wall 21a, a pair of side walls 21b extending upright from the both sides of the bottom wall 21a and a pair of flange walls 21c extending from the upper end of each sidewall 21b. The flange walls are bent inwardly and are extending downward. The lower rail 21 has a U-shaped cross section forming an opening 21d (FIG. 3) provided between the flange walls 21c and open upwardly. The lower rails 21 are fixed to the vehicle floor 11 (FIG. 1) by means of fastening bolts at the front and rear portions thereof.

The upper rail 22 has an elongated rectangular shape extending in the vehicle front/rearward direction and has a reverse U-shaped cross section. The upper rails 22 are shown as a pair of right and left rails as shown in FIG. 2 and arranged in parallel with each other in a vehicle width direction. The upper rail 22 includes a bottom wall 22a at the upper side, a pair of side walls 22b extending downward from the both sides of the bottom wall 22a and a pair of flange walls 22c extending from the lower end of the each side wall 22b and bending outwardly and extending upwardly. The upper rail 22 has an opening 22d open downward between the flange walls 22c. The side walls 22b are slidably engaged with the side walls 21b of the lower rail 21. The seat cushion 13 of the vehicle seat 10 is fixed to the upper rail 22 through a plurality of brackets 127.

As shown in FIG. 2, a pair of screws 23 is provided between right/left lower and upper rails 21 and 22. The axial center of each screw extends in front/rearward direction. Front end support brackets 24 are secured to each front end of the upper rail 22 by means of bolt 24a and nut 24c and rear end support brackets 25 are secured to each rear end of the upper rail 22 by mean of the bolt 25a and nut 25c. The bolt 24a for securing the front end support bracket 24 is provided with a support hole 24b and the rear end support bracket 25 is provided with a support hole 25b into which the screw 23 is inserted. Sliding members (not shown) are disposed in the support holes 24b and 25b to slidably rotate the screw 23.

A gearbox 26 is fixed to each front end of the front end support bracket 24. The gearbox 26 includes a worm wheel coaxially splined with the screw 23 and a worm shaft engaged with the worm wheel. The gearbox 26 is provided at the right and left side brackets 24.

A rotation transmitting shaft 27 is provided between the right and left gearboxes 26 extending in right/left direction. The right and the left ends of the rotation transmitting shaft 27 are connected to the each worm shafts of the gearbox 26. An output shaft of a motor 28 is connected to the rotation transmitting shaft 27 for transmitting the rotational torque from the motor 28 to the screw 23 through the worm shaft and worm wheel of the gearbox 26.

Reinforcement bracket 20 is provided above the rotation transmitting shaft 27 and the right and left side gearboxes 26. The reinforcement bracket 20 has an elongated rectangular shape extending in a right and left direction. The reinforcement bracket 20 includes a front bent portion 20m at the front side and a rear end bent portion 20n at the rear side.

The reinforcement bracket 20 further includes an engagement hole 20f for engaging an upper portion of the connection portion of the rotation transmitting shaft 27 with the motor 28 and a pair of fixing portions 20g for fixing the gearboxes 26 at both ends. A slit 20h is provided at the fixing portion 20g and is engaged with a projection 26a of the gearbox 26. The reinforcement bracket 20 and the gearbox 26 are fixed to the upper rail 22 by inserting screw 20k into a hole 26b of the gearbox 26, a hole (not shown) to be provided at the front end support bracket 24, holes 20i and 20j provided at the bent portions 20m and 20n of the fixing portion 20g of the bracket 20 and fastening by nut (not shown).

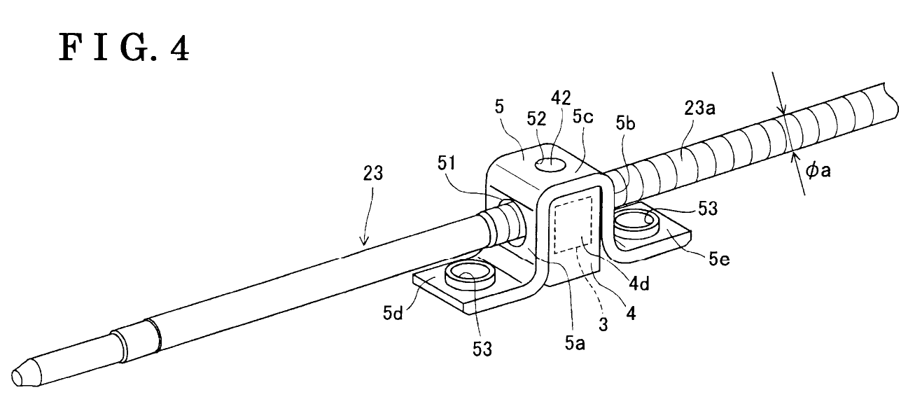

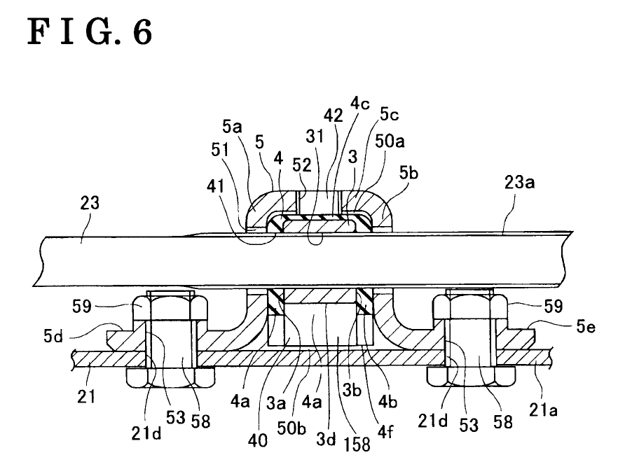

The screw 23 includes a male screw portion 23a (FIG. 4, FIG. 6) at the outer peripheral portion with which the female screw portion 31 (FIG. 6) engages. The female screw portion 31 is provided at the feeder nut 3.

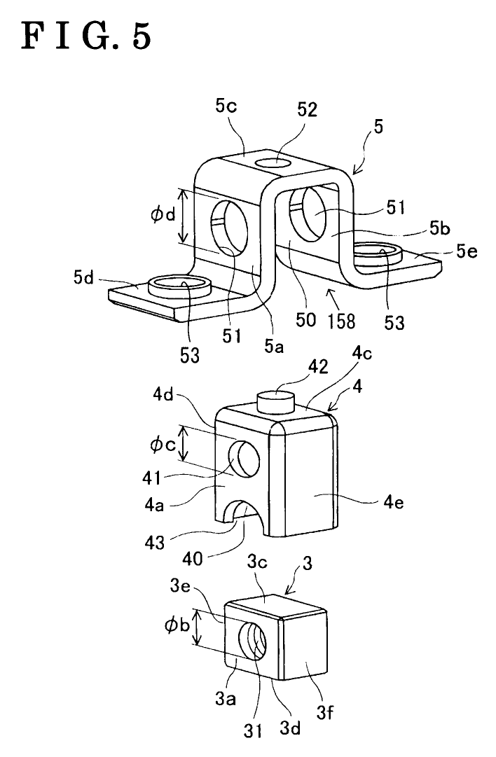

The feeder nut 3 is disposed in the support bracket 5 fixed to the bottom wall 21a of the lower rail 21. As clearly shown in FIGS. 5 and 6, the feeder nut 3 is formed with the female screw portion 31 which is engaged with the male screw portion of the screw 23 and is movable in an axial direction relative to the screw 23. The feeder nut 3 is of columnar shape. The feeder nut 3 includes front/rear walls 3a and 3b provided opposite to the front/rear side in an axial direction and upper and lower walls 3c and 3d intersecting the screw 23 in an axial direction and a pair of side walls 3e and 3f. The female screw 31 opens to the front/rear walls 3a and 3b.

The feeder nut 3 is supported by the support bracket 5 via an elastic case 4. The elastic case 4 is formed by an elastic material, such as rubber and is provided with an accommodation portion 40 for accommodating the feeder nut 3 therein. The feeder nut 3 includes a nut portion on which the female screw 31 is formed and an outer profile portion supported by the elastic case 4.

The elastic case 4 includes front/rear walls 4a and 4b provided opposite to each other at the front and rear sides in an axial direction, upper wall 4c intersecting in an axial direction and the side walls 4d and 4e. The feeder nut 3 is press-fitted into the accommodation portion 40 of the elastic case 4 and is elastically supported thereby to be in contact with the front/rear walls 4a and 4b, the side walls 4d and 4e at the front and rear walls 3a and 3b and side walls 3e and 3f as the pressure contact surfaces for the feeder nut 3. The support hole 41 is open to the front and rear walls 4a and 4b into which the screw 23 is inserted for supporting. Lower side of the accommodation portion 40 includes an opening 43 and the upper wall 4c has a projection 42 for defining an accurate positioning.

The support bracket 5 includes front and rear walls 5a and 5b provided opposite to the front and rear sides of the screw 23 in an axial direction, a space 50 formed between one of the front and rear walls and the other of the front and rear walls disposing therein the accommodation portion 40, upper wall 5c as a connection wall to connect the front side of the front/rear walls 5a and 5b with the rear side of the front/rear walls 5a and 5b at upper side of the accommodation portion 40 and a pair of flange walls 5d and 5e extending from the front and rear walls 5a and 5b and bent to form a flange shape. An opening 51 is provided at the front and rear walls 5a and 5b for inserting the screw 23 therethrough. An engagement hole 52 is provided at the upper wall 5c for engaging the positioning projection 42 for positioning the elastic case 4 to the right place. The support bracket 5 is fixed to the lower rail 21 by inserting bolts 58 into the bolt holes 53 provided at the flange walls 5d and 5e and holes 21d provided at the bottom wall 21a of the lower rail 21, respectively and fastening with the nuts 59. The other end of the upper wall 5c of the support bracket 5 has an opening 158 and through which the elastic case 4 and the bottom wall 21a of the lower rail 21 are arranged to face with each other through a second space 50b.

FIG. 4 and FIG. 5 explain the size or dimensional relationship of the components, screw 23, feeder nut 3, elastic case 4 and support bracket 5. The inner diameter φb of the female screw portion 31 of the feeder nut 3 is set to be larger than the outer diameter φa of the male screw portion 23a of the screw 23. The inner diameter φc of the support hole 41 of the elastic case 4 is set to be smaller than the outer diameter φa of the male screw portion 23a by about 0.2 mm so that the elastic case 4 can elastically support the screw 23. The inner diameter φd of the opening 51 of the support bracket 5 is larger than the outer diameter φa of the male screw portion 23a so that the male screw portion 23a can rotate within the opening 51a. The male screw portion 23a, female screw portion 31 of the feeder nut 3, support hole 41 of the elastic case 4 and the opening 51 of the support bracket 5 are arranged to be co-central and co-axial.

As shown in FIG. 5 or FIG. 6, the dimensional size of the accommodation portion 40 is set to be somewhat smaller than the outer dimensional size of the feeder nut 3 so that the feeder nut 3 can be press-fitted in the accommodation portion 40 from the downward opening 43. The feeder nut 3 is elastically supported by contacting with the inner peripheral portion of the elastic case 4. When the feeder nut 3 is inserted into the accommodation portion 40, the feeder nut 3 is accurately positioned relative to the elastic case 4 by opposing the walls 3a, 3b, 3c, 3e and 3f of the feeder nut 3 to the walls 4a, 4b, 4c, 4d and 4e of the elastic case 4.

The outer dimensional size of the elastic case 4 is set to be somewhat larger than the size of the space 50 of the support bracket 5 so that the elastic case 4 can be press-fitted in the space 50 from the lower side. Thus the support bracket 5 can support the elastic case 4. The elastic case can be positioned relative to the support bracket 5 by engaging the positioning projection 42 of the case 4 with the hole 52 of the support bracket 5. The walls 4a and 4b of the elastic case 4 are pressed against the walls 5a and 5b of the bracket 5 to be elastically compressed for adjusting the relative position.

A first gap 50a is provided between an outer surface of the upper wall 4c of the elastic case 4 and an inner surface of the upper wall 5c of the support bracket 5 and a second gap 50b is provided between a lower end surface 4f of the side walls 4d and 4e of the elastic case 4 and an upper surface of the bottom wall 21a of the lower rail 21. Accordingly, the vertical position of the elastic case 4 relative to the support bracket 5 can be adjustable.

As shown in FIG. 5 or 6, assembling of the screw 23, feeder nut 3, elastic case 4 and the support bracket 5 to the lower rail 21 will be explained. First, the feeder nut 3 is press-fitted in the accommodation portion 40 of the elastic case 4 from the downward opening 43. Next, the elastic case 4 assembled with the feeder nut 3 is press-fitted in the space 50 of the support bracket 5. Next, the screw 23 is engaged with female screw portion 31 of the feeder nut 3 by inserting into the opening 51 of the support bracket 5 and the support hole 41 of the elastic case 4. Thereafter, the front end support bracket 24 and the rear end support bracket 25 are rotatably attached to the front and rear ends of the screw 23. Then the bolts 58 are inserted into the bolt holes 53 provided at the flange walls 5d and 5e of the support bracket 5 and by fastening the bolts 58 with the nuts 59, the support bracket 5 is fixed to the lower rail 21. The front and rear end brackets 24 and 25 are fixed to the front and rear ends of the upper rail 22 by fastening the bolts 24a and 25a with the nuts 24c and 25c. The male screw portion 23a of the screw 23, female screw portion 31 of the feeder nut 3, support hole 41 of the elastic case 4 and the opening 51 of the support bracket 5 are arranged in concentric manner.

In the first embodiment of the invention, as shown in FIG. 6, the elastic case 4 provided between the feeder nut 3 and the support bracket 5 elastically holds the male screw portion 23 of the screw 23 at the inner peripheral portion of the support hole 41. The elastic force at the inner peripheral portion of the support hole 41 relieves the radial thrust force of the male screw portion 23a of the screw 23 applied on the female screw portion 31 of the feeder nut 3. This will obviate or reduce the screw engagement noise which may be generated between the screw 23 and the feeder nut 3 upon engagement therebetween, which leads to a smooth feeding operation. For example, when the male screw portion 23a rotates around the rotation center of the screw 23 due to a very little deviation (twisting), the elastic case 4 is elastically deformed by this revolution of the male screw portion 23a, since the inner peripheral surface of the support hole 41 of the case 4 keeps holding of the male screw portion 23a. The feeder nut 3 pressed by the elastic case 4, is displaced in response to the revolution of the male screw portion 23a to decrease the positioning deviation of the feeder nut 3 relative to the female screw portion 31 of the feeder nut 3. This, in turn, reduces the thrusting force of the male screw portion 23a against the female screw portion 31 of the nut 3 in a radial direction. Even when the male screw portion 23a contacts upon the female screw portion 31, the noise generated upon contact or impact may be minimized due to the elastic holding operation between the feeder nut 3 and the support bracket 5 through the elastic case 4.

Since the elastic case 4 is provided between the feeder nut 3 and the support bracket 5, the contact impact generated between the male screw portion 23a of the screw 3 and the female screw portion 31 of the feeder nut 3 upon engagement operation due to backrush can be avoided or minimized when the screw rotation direction is switched.

Further, since the screw 23 is attached to the upper rail 22 and the support bracket 5 is attached to the lower rail 21, positional deviation may be generated due to the tolerance error in size and in assembling. According to this embodiment, this positional deviation can be absorbed by the elasticity of the elastic case 4 provided between the screw 23 and the bracket 5.

The inner diameter φc of the support hole 41 is set to be smaller than the outer diameter φa of the male screw portion 23a of the screw 23. This will reduce the radial contact impact between the male screw portion 23a of the screw 3 and the female screw portion 31 of the feeder nut 3 by elastically holding the male screw portion 23a to the entire inner periphery of the hole 41.

The first gap 50a (space) and the second gap (space) 50b are provided between the upper wall 4c of the elastic case 4 and the upper wall 5c of the support bracket 5 and the lower end of the elastic case 4 and the bottom wall 21a of the lower rail 21. This will allow the elastic case 4 to move in an upward/downward direction for a vertical position adjustment within the space 50 of the support bracket 5. Thus the vertical deviation between the screw 23 and the support bracket 5 can be adjusted.

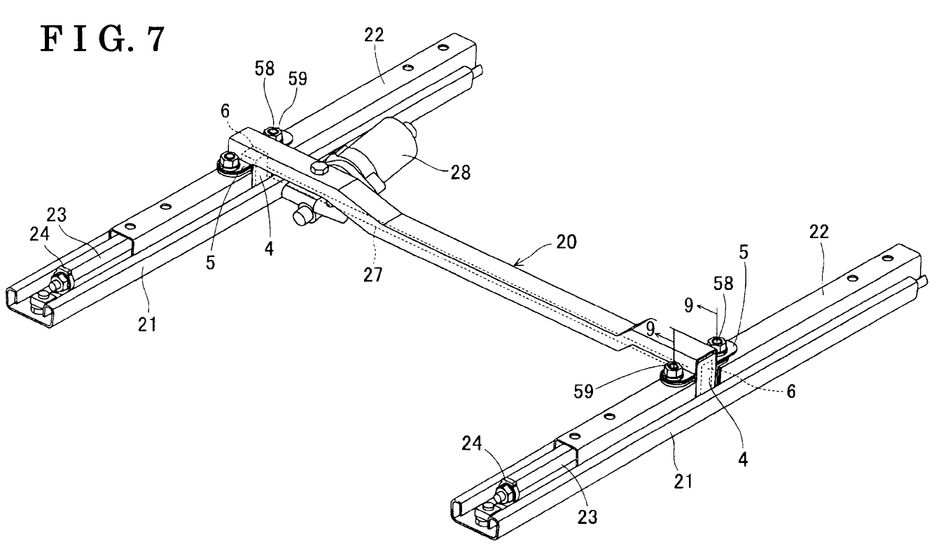

According to the second embodiment, as shown in FIG. 7, instead of using the feeder nut 3 of the first embodiment, a nut side member 6 having a drive side nut is provided. The motor drives the nut side member 6. By the rotation of the drive side nut, the nut side member 6 is moved in front/rearward direction relative to the screw 23. The nut side member 6 is fixed to the upper rail side whereas the screw 23 is held at the lower rail side.

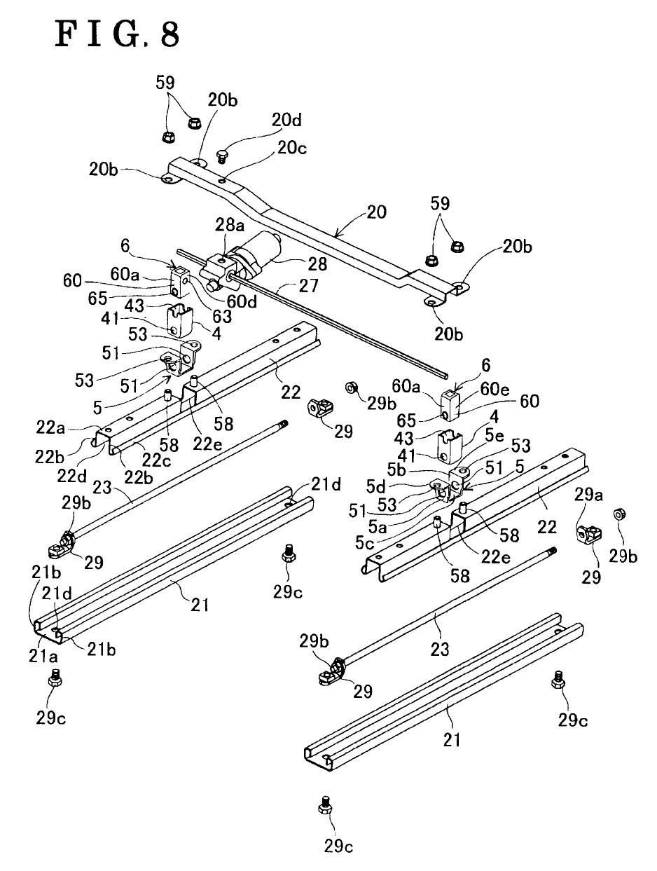

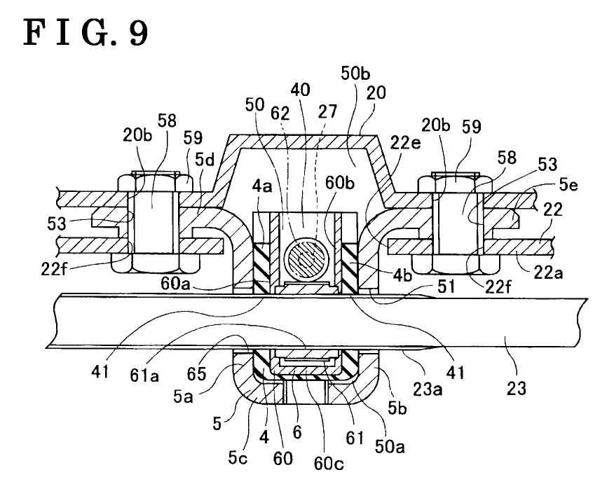

According to the second embodiment, as shown in FIGS. 8 and 9, the nut side member 6 includes a casing 60, a drive side nut 61 (nut) and a worm shaft 62. The drive side nut 61 includes a female screw portion 61a with which the male screw portion 23a of the screw 23 engages. The casing 60 accommodates the screw 23 and the worm shaft 62. A worm wheel is provided on the outer peripheral portion of the drive side nut 61. The worm shaft 62 is connected to the motor 28 through the rotation transmitting shaft 27. A reinforcement bracket 20 is provided above the rotation transmitting shaft 27 and the motor 28 is connected to the reinforcement bracket 20 by the engagement of the bolt 20d with engagement bore 28a and the insertion hole 20c.

The casing 60 has a quadrangular shape and includes a pair of front/rear walls 60a and 60b facing with each other in axial direction relative to the screw 23, lower wall 60c and a pair of side walls 60d and 60e. One side wall 60d facing seat inside has an opening 63 for inserting the rotation transmitting shaft 27. The front/rear walls 60a and 60b have a hole 65 into which the screw 23 is inserted. The casing 60 is formed by a pair of divided members which are connected in one piece after the drive side nut 61 and the worm shaft 62 are accommodated.

The nut side member 6 is press-fitted in the accommodation portion 40 of the elastic case 4 and the elastic case 4 is disposed in the space 50 of the support bracket 5 allowing a relative movable gap for positioning adjustment therebetween when assembly. The support bracket 5 is disposed in a recess 22e formed at the upper rail 22 at an approximately central position in a longitudinal direction relative to the upper wall 22a and the side wall 22b. The support bracket 5 and the reinforcement bracket 20 are fixed to the upper rail 22 by inserting the bolt 58 into the bolt hole 22f provided near the recess 22e and the bolt hole 53 of the support bracket 5 and fastening by the nut 59.

The front end and the rear end of the screw 23 in an axial direction are fixed to the fixing bracket 29 by inserting the axial hole 29a formed at the fixing bracket 29 and fastening the nut 29b. The fixing bracket 29 is fixed to the lower rail 21 by bolt 29c at the bottom wall 21a.

The elastic case 4 is press-fitted in the casing 60 of the nut side member 6 and the support bracket 5 according to the embodiment illustrated in FIG. 8 or 9 and the inner diameter φc of the support hole 41 is smaller than the outer diameter φa of the male screw portion 23a. This will reduce the radial contact impact between the male screw portion 23a of the screw 3 and the female screw portion 61 of the drive side nut 61 by elastically holding the male screw portion 23a to the entire inner periphery of the hole 41.

Since the elastic case 4 is provided between the nut side member 6 and the support bracket 5 (support member), the contact impact generated between the male screw portion 23a of the screw 3 and the female screw portion 61 of the drive side nut 61 upon engagement operation due to backrush can be avoided or minimized when the screw rotation direction is switched.

According to the embodiment of the invention, the feeder device includes the support hole 41 of the elastic case 4 having an inner diameter φc smaller than an outer diameter φa of the screw 23 and the inner peripheral surface of the support hole to be in pressure contact with the male screw portion 23a of the screw 23.

This structure of the feeder device has an advantage that the radial contact impact between the male screw portion 23a of the screw 3 and the female screw portion 31 of the feeder nut 3 can be reduced by elastically holding the male screw portion 23a to the entire inner periphery of the hole 41.

According to another feature of the embodiment, the support bracket 5 (the support member 5) includes a pair of front and rear walls 5a and 5b each opposing in an axial direction and the elastic case 4 is in box shape to be in pressure contact with the front and the rear walls 5a and 5b of the support bracket 5 (support member).

According to this feature, since the elastic case 4 has a box shape, the nut side member 6 can be securely held at the four sides.

According to still another feature of the embodiment, the support bracket 5 includes an opening 158 at opposite side relative to the connecting wall 5c, the elastic case 4 opposes the lower rail 21 (fixed member) through the opening 158 and wherein a second space 50b is provided between the elastic case 4 the fixed member 21.

In this feature of the embodiment, when the positioning deviation between the screw and 23 the support bracket is large, the elastic case can be moved relative to the support bracket and adjust the gap within the first space 50a.

The fixed member is a lower rail 21 adapted to be installed at a vehicle floor 11 and the feeder device is adapted to be used for a vehicle slide device 10. The movable member is an upper rail 22 on which a vehicle seat 10 is supported and movable relative to the lower rail 21 in a vehicle front/rear direction.

The embodiment is shown as an example of being applied to a vehicle seat slide device 12. The feeder device of this embodiment can achieve a smooth seat slide operation without making any noise caused by the backrush.

The feeder device according to an embodiment of the invention, the support member 5 includes a connecting wall 5c (the upper wall 5c) opposing the elastic case 4 in a radial direction relative to the screw 23 and connecting the pair of front and rear walls 5a and 5b and a first space or a first gap 50a is provided between the elastic case 4 and the connecting wall 5c of the support member 5.

According to the structure above, since the first space 50a is provided between the elastic case 4 and the support member 5, a small positional deviation between the screw 23 and the support member 5 can be absorbed by the first space 50a by the movement of the case 4 relative to the support member 5.

Further, support member 5 includes an opening 158 at opposite side relative to the connecting wall 5c, the elastic case 4 opposes the lower rail 21 (the fixed member) through the opening 158 and wherein a second space 50b is provided between the elastic case 4 and the upper rail 22 (movable member).

According to the structure above, since the second space 50b is provided between the elastic case 4 and the upper rail 22 (movable member), a small positional deviation between the screw 23 and the support member 5 can be absorbed by the first space 50a by the movement of the case 4 relative to the support member 5.

According to the embodiments, the feeder device is applied to the seat slide device 12. However, the application of the feeder device is not limited to the seat slide device. The feeder device is applicable to any seat position adjusting device. For example, a seat height adjusting device, a seat reclining device, or a headrest height-adjusting device may be applied as the seat position-adjusting device.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What we claim:

1. The feeder device including:
a screw adapted to be attached to either one of a fixed member and a movable member relatively movably supported by the fixed member;
a support member adapted to be attached to the other one of the fixed member and the movable member and including a through-hole into which the screw is inserted;
a nut-side member disposed inside of the support member and including a nut having a female screw portion, with which a male screw portion provided at the screw engages, the nut-side member being relatively movable in an axial direction relative to the screw;
an elastic case formed by an elastic material and disposed between the nut-side member and the support member, the elastic member including a support hole, axial center of which is the same with that of the female screw portion and elastically holding the male screw portion at an inner peripheral surface thereof and a pressure-contact surface elastically holding the nut-side member by a pressure contact therewith; and
a drive device for drivingly rotating either the screw or the nut of the nut-side member.

2. The feeder device according to claim 1, wherein the support hole of the elastic case has an inner diameter smaller than an outer diameter of the screw and the inner peripheral surface of the support hole is in pressure contact with the male screw portion of the screw.

3. The feeder device according to claim 1, wherein the support member includes a pair of front and rear walls each opposing in an axial direction and the elastic case is in box shape to be in pressure contact with the front and the rear walls of the support member.

4. The feeder device according to claim 3, wherein the support member further includes a connecting wall opposing the elastic case in a radial direction relative to the screw and connecting the pair of front and rear walls and a first space is provided between the elastic case and the connecting wall of the support member.

5. The feeder device according to claim 4, wherein the support member includes an opening at opposite side relative to the connecting wall, the elastic case opposes the other of the fixed member and the movable member through the opening and wherein a second space is provided between the elastic case and the other of the fixed member and the movable member.

6. The feeder device according to claim 1, wherein the fixed member is a lower rail adapted to be installed at a vehicle floor and the feeder device is adapted to be used for a vehicle seat slide device.

7. The feeder device according to claim 6, wherein the movable member is an upper rail on which a vehicle seat is supported and movable relative to the lower rail in a vehicle front/rear direction.
